(19) United States
(12) Patent Application Publication
(10) Pub. No.: US 2015/0059186 A1
(43) Pub. Date: Mar. 5, 2015

(54) HAND-HELD POWER TOOL INFORMATION DEVICE

(71) Applicant: Robert Bosch GmbH, Stuttgart (DE)

(72) Inventors: Christian Bermes, Solothurn (CH); Martial Luepold, Hubersdorf (CH); Bruno Sinzig, Oberbipp (CH)

(21) Appl. No.: 14/470,401

(22) Filed: Aug. 27, 2014

(30) Foreign Application Priority Data
Aug. 29, 2013 (DE) 10 2013 217 290.7

(51) Int. Cl. B23D 59/00; B27B 9/00; G01B 11/14

(52) U.S. Cl. CPC B23D 59/001; G01B 11/14; B27B 9/00
USPC 30/123; 702/158

(57) ABSTRACT

A hand-held power tool information device includes at least one detection unit configured to detect at least one processing distance covered by a cutting edge of a processing tool on a workpiece. The detection unit is also configured to detect the at least one processing distance independently of a guide rail. The hand-held power tool information device can further include a distance sensor unit that is configured to detect at least one distance value.

This application claims priority under 35 U.S.C. §119 to patent application no. DE 10 2013 217 290.7 filed on Aug. 29, 2013 in Germany, the disclosure of which is incorporated herein by reference in its entirety.

### BACKGROUND

A hand-held power tool information device for a plunge circular saw, said device comprising a least one detection unit, is already known from DE 10 2009 050 551 A1. The detection unit is provided for the purpose of detecting at least one processing distance that has been covered by a cutting edge of a processing tool on a workpiece that is being processed. A guide rail comprising a magnetic tape is provided for the purpose of detecting the processing distance covered. The magnetic strip is magnetized in regular portions with a magnetic north pole and a magnetic south pole. It is possible by way of a magneto-resistive sensor to detect a processing distance covered. An actual saw cutting length is detected by way of a computer unit from the processing distance covered, a saw blade diameter and a plunge depth of the processing tool. The saw cutting length can be read out by way of a display.

### SUMMARY

The disclosure relates to a hand-held power tool information device comprising at least one detection unit that is provided for detecting at least one processing distance that has been covered by a cutting edge of a processing tool on a workpiece that is being processed.

It is proposed that the at least one detection unit is provided for the purpose of detecting in a manner that is independent of guide rails the at least one processing distance that has been covered by the cutting edge of a processing tool. In an advantageous manner, the at least one detection unit is provided for detecting in a manner that is independent of guide rails the at least one processing distance that has been covered by the cutting edge of the processing tool in dependence upon at least one processing tool parameter.

The term “detection unit” is to be understood in this context to mean in particular a unit that is provided for the purpose of acquiring a value, in particular detecting an actual processing distance of a processing tool. The value can be acquired directly, by way of example by means of a camera and/or my means of a special sensor, in particular an ultrasonic sensor. However, it is preferred that the value is acquired by means of calculating different values and/or processing tool parameters. The term “processing distance” is to be understood in this context to mean in particular a length of an area on a workpiece surface of the workpiece that has been processed by the processing tool. The workpiece surface corresponds to a processing plane on which the hand-held power tool information device is moved at least in part in a processing direction. It is preferred that the processing distance corresponds to a cut length of a cut in the workpiece. It is particularly preferred that the processing distance extends at least essentially parallel to a cutting plane of the processing tool. The term “essentially parallel” is to be understood in this case to mean in particular an orientation of a direction relative to a reference direction, in particular a plane, wherein the direction deviates with respect to the reference direction in particular less than 8°, advantageously less than 5° and particularly advantageously less than 2°. Cutting edges of the cutting teeth of the processing tool extend preferably at least essentially in a transverse manner with respect to the cutting plane of the processing tool. The term “at least essentially in a transverse manner” is to be understood in this case to mean in particular an orientation of a plane and/or of a direction relative to a further plane and/or a further direction that preferably deviates from a parallel orientation of the plane and/or from the direction relative to the further plane and/or to the further direction. The processing tool can be embodied as a milling tool. It is preferred that the processing tool is embodied as a planing tool. It is particularly preferred that the processing tool is embodied as a circular saw blade. Consequently, the processing tool exerts a rotating movement for the purpose of introducing a cut into the workpiece, preferably in the cutting plane of the processing tool. For the purpose of introducing a cut into the workpiece, the cutting plane extends preferably at least essentially in a transverse manner with respect to the workpiece surface of the workpiece that is being processed. The cutting edge extends in particular at least essentially parallel to the cutting edges of the cutting teeth of the processing tool. A feed direction extends preferably at least essentially parallel to the cutting plane of the processing tool. The term “in a manner that is independent of a guide rail” is understood in this context to mean in particular in a manner that is not dependent upon a guide rail. The term “processing tool parameter” is to be understood in this context to mean in particular a parameter that comprises a plunge depth value and/or a processing tool dimension, preferably a processing tool diameter. The term “provided” is to be understood to mean in particular especially programmed, designed and/or embodied. It is possible by means of the design in accordance with the disclosure of the hand-held power information device to detect in a manner that is independent of a guide rail a cutting length of a cut. As a consequence, the hand-held power information device can be used to cover a particularly varied range of applications. As a consequence, it is advantageously possible in a simple manner to be more precise when processing a workpiece.

It is proposed in a further embodiment of the disclosure that the at least one detection unit comprises a distance sensor unit that is provided for the purpose of detecting in a manner that is independent of a guide rail at least one distance value, in particular a hand-held tool reference point, as a consequence of which it is possible to detect the cutting length in a particularly precise manner. The term “distance sensor unit” is to be understood in this context to mean a unit that comprises at least one distance sensor. It is preferred that the distance sensor unit is provided for the purpose of detecting an absolute distance. It is particularly preferred that the distance sensor unit is provided for the purpose of detecting a distance covered. The distance sensor unit comprises in an advantageous manner an incremental distance sensor. The term “distance value” is to be understood in this context to mean in particular a value regarding a covered distance of a hand-held tool reference point and/or a distance of the hand-held tool reference point with respect to another reference point, in particular with respect to a target point. The term “hand-held tool reference point” is to be understood in this context to mean in particular a reference point of a hand-held power tool that comprises a fixed position with respect to a contact unit and/or with respect to a power tool housing of the hand-held power tool. It is preferred that the hand-held tool reference point has a fixed position with respect to a plunge pivot axis.

Furthermore, it is proposed that the at least one detection unit comprises a computer unit that is provided for the purpose of calculating the processing distance of the cutting edge of the processing tool on the workpiece that is being processed in dependence upon the at least one processing tool parameter and at least one distance value. The term “computer unit” is to be understood in particular to mean a unit comprising an information input, an information processing unit and an information output. In an advantageous manner, the computer unit comprises at least one processor, a storage medium, input and output means, further electrical components, an operating program, regulating routines, control routines and/or calculating routines. It is preferred that the components of the computer unit are arranged on a common printed circuit board and/or are arranged in an advantageous manner in a common housing. As a consequence, the processing distance can be detected in a simple and cost-effective manner. In an advantageous manner, the computer unit is provided for the purpose of calculating a remaining processing distance.

Furthermore, it is proposed that the at least one detection unit comprises at least one plunge depth sensor unit that is provided for the purpose of acquiring the current plunge depth value of the processing tool, as a consequence of which it is possible to calculate a cutting depth in a particularly comfortable and precise manner. The term “plunge depth sensor unit” is to be understood in this context to mean in particular a unit that is provided for the purpose of detecting a plunge depth angle of a processing tool about a plunge pivot axis. The term “plunge depth value” is to be understood in this context to mean in particular a value that comprises at least a plunge depth angle and/or at least a plunge depth. The plunge depth sensor unit is provided for the purpose of transmitting the current plunge depth value to the computer unit. The plunge depth sensor unit is connected for this purpose in an electric manner to the computer unit.

Moreover, it is proposed that the computer unit is provided for the purpose of detecting the processing distance in dependence upon the current plunge depth value, as a consequence of which the comfort of the operator can be increased in an advantageous manner. Furthermore, a processing distance can be detected in a particularly precise manner in dependence upon the current plunge depth value. The computer unit is preferably provided for the purpose of calculating the processing distance in dependence upon real time from the plunge depth value.

If the hand-held power tool information device comprises an input unit by way of which it is possible to input at least one operating value, the at least one detection unit can be adapted in a flexible manner to suit different operating parameters. The term “input unit” is to be understood in this context to mean in particular a unit that comprises at least one input element that is provided for the purpose of transmitting a user input to the at least one detection unit. The term “operating value” is to be understood in this context to mean in particular a processing tool parameter, a guide rail parameter, a total cutting length and/or a processing distance covered. The term “guide rail parameter” is to be understood in this context to mean in particular a value regarding the presence of a guide rail.

In an advantageous manner, the input unit comprises at least one touch screen, as a consequence of which a particularly intuitive user input can be achieved. In addition, it is proposed that the input unit is formed by a mobile telephone. Accordingly, the touch screen can also be part of the mobile telephone.

In a further embodiment of the disclosure, it is proposed that the distance sensor unit comprises at least one distance sensor element that is provided for the purpose of acquiring the at least one distance value in an optical manner, as a consequence of which it is possible in a particularly simple manner to measure the distance in a manner that is independent of a guide rail. In addition or as an alternative thereto, it is proposed that the distance sensor unit comprises at least one distance sensor element that is provided for the purpose of acquiring in an acoustic and/or electromagnetic manner the at least one value relating to the distance covered.

Furthermore, it is proposed that the hand-held power tool information device comprises at least one hand-held tool reference point and the distance between said reference point and the cutting edge of the processing tool can be stored and/or calculated in the computer unit. As a consequence, it is possible to establish a particularly simple definition of a starting point and termination point of a processing distance.

If the hand-held power tool information device comprises an output unit that is provided at least for the purpose of outputting the at least one processing distance, a value, in particular regarding the processing distance, can be output in a particularly user-friendly manner. The term “output unit” is understood to mean in this context in particular a unit that is provided for the purpose of outputting an optical, acoustic and/or haptic signal for a user. In an advantageous manner, the output unit comprises at least one optical output means. It is preferred that the optical output means is embodied by a light diode, a segment display and/or in a particularly preferred manner from a display, in particular a liquid crystal display.

Furthermore, a system is proposed that comprises a hand-held power tool, in particular a circular saw, and comprises a hand-held power tool information device in accordance with the disclosure. The term “hand-held power tool” is to be understood in this context to mean in particular a power tool that can be transported by an operator without the use of a transportation machine. The hand-held power tool comprises in particular a mass that is less than 40 kg, preferably less than 10 kg and particularly preferred less than 5 kg. It is particularly preferred that the hand-held power tool is embodied as a plunge circular saw. However, it is also feasible that the hand-held power tool has a different embodiment that appears expedient to a person skilled in the art, such as in particular an embodiment as a router. It is preferred that the hand-held power tool information device is integrated in the hand-held power tool. In addition, it is proposed that the hand-held power tool information device is embodied in such a manner that it can be detached from the hand-held power tool. Moreover, it is proposed that the hand-held power tool information device is embodied separately in an operating state from the hand-held power tool.

The hand-held power tool in accordance with the disclosure and/or the system in accordance with the disclosure is/are not to be limited to the above described application and embodiment. In particular, the hand-held power tool information device in accordance with the disclosure and/or the system in accordance with the disclosure can comprise a number of individual elements, components and units that differs from a number mentioned herein for the purpose of fulfilling a method of functioning described herein.

### BRIEF DESCRIPTION OF THE DRAWINGS

Further advantages are evident in the following description of the drawing. Exemplary embodiments of the disclosure are illustrated in the drawing. The drawing, the description and the claims disclose numerous features in combination. The person skilled in the art will also consider in a purposeful manner the features individually and combine said features to form expedient further combinations.

In the drawing:

FIG. 1 illustrates a perspective view of a hand-held power tool that comprises a hand-held power tool information device in accordance with the disclosure,

FIG. 2 illustrates a schematic illustration of the hand-held power tool information device according to FIG. 1,

FIG. 3 illustrates a schematic structure of the hand-held power tool information device according to FIG. 1,

FIG. 4 illustrates a perspective view of a hand-held power tool and a hand-held power tool information device in an alternative embodiment,

FIG. 5 illustrates a perspective view of a hand-held power tool and a hand-held power tool information device in an alternative embodiment,

FIG. 6 illustrates a perspective view of a further hand-held power tool that comprises a hand-held power tool information device, and

FIG. 7 illustrates a perspective view of a further hand-held power tool that comprises a hand-held power tool information device.

### DETAILED DESCRIPTION

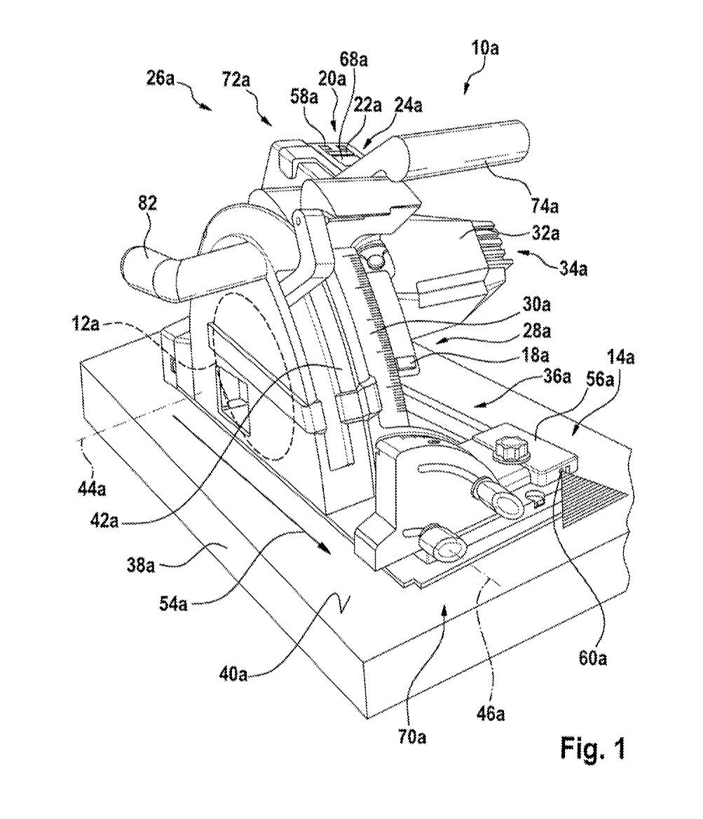

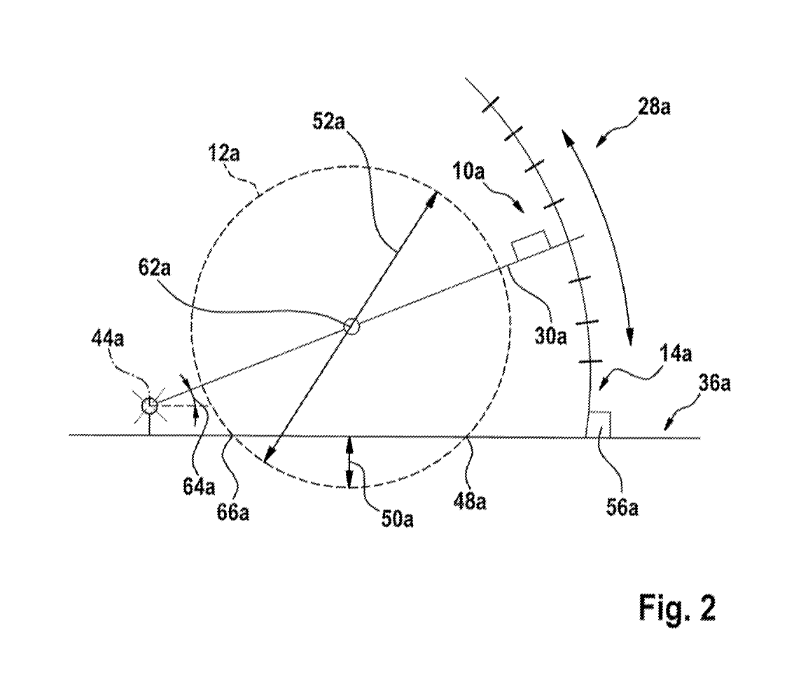

FIGS. 1 and 2 illustrate a system comprising a hand-held power tool 26a and a hand-held power tool information device. The hand-held power tool 26a is embodied as a plunge circular saw. The hand-held power tool 26a comprises at least one cutting depth adjusting unit 28a. The cutting depth adjusting unit 28a is provided for the purpose of adjusting a cutting depth 50a of a processing tool 12a. It is possible by adjusting a position of a cutting depth adjusting element 30a to adjust the cutting depth 50a of the processing tool 12a in a manner already known to a person skilled in the art. The processing tool 12a is connected to a tool receiving device (not illustrated in detail in this figure) of the hand-held power tool 26a. The processing tool 12a is embodied as a circular saw blade. The hand-held power tool 26a comprises furthermore a hand-held power tool housing 32a. The hand-held power tool housing 32a is provided for the purpose of encompassing a drive unit 34a of the hand-held power tool 26a. The drive unit 34a comprises a drive shaft (not illustrated in detail in this figure) that is provided in a manner already known to the person skilled in the art for the purpose of driving the processing tool 12a that can be coupled to the tool receiving device.

Furthermore, the hand-held power tool 26a comprises a contact unit 36a. The contact unit 36a is embodied as a base plate or as a sliding piece. During processing work on a workpiece 38a, the contact unit 36a lies on a workpiece surface 40a of the workpiece 38a. In other words, the contact unit 36a slides on the workpiece surface 40a during a movement of introducing a cut into the workpiece 38a. As an alternative thereto, the contact unit 36a lies on a surface of a guide rail (not illustrated in this figure) during processing work on a workpiece 38a. The contact unit 36a can in this case be coupled to the guide rail in a manner already known to a person skilled in the art.

In addition, a protection unit 42a of the hand-held power tool 26a is arranged on the contact unit 36a and said protection unit protects an operator from being injured during processing work on the workpiece 38a. The protection unit 42a is embodied as a protection hood. The protection unit 42a encompasses the processing tool 12a in an assembled state along a direction of rotation of the drive shaft by more than 160°. The protection unit 42a further comprises a suction coupling element 82a. The suction coupling element 82a can be connected to a suction unit (not illustrated in detail in this figure) for the purpose of extracting any particles of workpiece that have been abraded during processing work on the workpiece 38a.

The hand-held power tool housing 32a is mounted on the protection unit 42a in such a manner as to be able to a pivot relative to the contact unit 36a. The hand-held power tool housing 32a is mounted on the protection unit 42a in a manner already known to a person skilled in the art in such a manner as to be able to pivot about a plunge pivot axis 44a relative to the contact unit 36a. Furthermore, the hand-held power tool housing 32a is mounted together with the protection unit 42a on the contact unit 36a in a manner already known to a person skilled in the art in such a manner as to be able to pivot about a tilt pivot axis 46a relative to the contact unit 36a. The plunge pivot axis 44a extends at least essentially in a perpendicular manner relative to the tilt pivot axis 46a. In addition, the cutting depth adjusting unit 28a is arranged on a face of the protection unit 42a that is facing the hand-held power tool housing 32a.

The hand-held power tool information device is fixedly arranged on the hand-held power tool 26a. The hand-held power tool information device comprises a detection unit 10a. The detection unit 10a is provided for the purpose of detecting a processing distance covered by a cutting edge 48a of the processing tool 12a on the workpiece 38a that is being processed. The detection unit 10a is provided for the purpose of detecting in a manner that is independent of a guide rail in dependence upon at least one processing tool parameter the processing distance covered by the cutting edge 48a of the processing tool 12a on the workpiece 38a that is being processed. The processing distance is a length of the processed cut that has been provided in the workpiece surface 40a by the processing tool 12a.

A processing tool parameter comprises the cutting depth 50a of the processing tool 12a. As the processing tool 12a is plunged into the workpiece 38a, the cutting depth 50a increases. A position of the cutting edge 48a of the processing tool 12a on the workpiece that is being processed 38a changes merely as the cutting depth 50a changes. In other words, the cutting edge 48a moves in a processing direction 54a as the cutting depth 50a changes. The processing tool 12a can be moved in a linear manner in the processing direction 54a during a processing procedure. The processing tool 12a exerts a rotating movement for the purpose of introducing a cut into the workpiece 38a in a cutting plane of the processing tool 12a. The processing direction 54a extends at least essentially parallel to the cutting plane of the processing tool 12a. A further processing tool parameter comprises a processing tool diameter 52a of the processing tool 12a.

The detection unit 10a comprises a distance sensor unit 14a. The distance sensor unit 14a is provided for the purpose of acquiring a distance value in a manner that is independent of a guide rail. The distance value comprises a distance that has been covered by a hand-held tool reference point 60a commencing from a starting point. The hand-held tool reference point 60a is arranged in a fixed position on the contact unit 36a. The distance sensor unit 14a comprises a distance sensor element 56a. The distance sensor element 56a is formed by an incremental distance sensor. The distance sensor element 56a is provided for the purpose of detecting in an optical manner the distance that has been covered by the hand-held tool reference point 60a in a processing direction 54a. The incremental distance sensor is preferably formed by an optical mouse sensor. The distance sensor element 56a is arranged directly on the hand-held tool reference point 60a. The distance sensor element 56a is arranged in a front region 70a of the hand-held power tool 26a. The hand-held tool reference point 60a is likewise arranged in the front region 70a of the hand-held power tool 26a. The front region 70a is arranged after the processing tool 12a when viewed in the processing direction 54a.

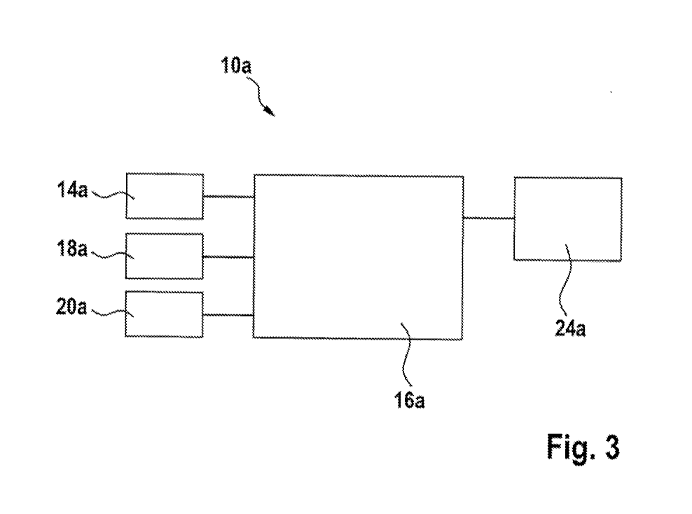

As illustrated schematically in FIG. 3, the detection unit 10a comprises a computer unit 16a for the purpose of processing the distance sensor value. The computer unit 16a is provided for the purpose of calculating the processing distance of the cutting edge 48a of the processing tool 12a on the workpiece that is being processed 38a in dependence upon the at least one processing tool parameter and the distance value. The computer unit 16a comprises for this purpose an information input (not identified in detail), an information processing unit and an information output.

The hand-held power tool information device comprises an input unit 20a. The input unit 20a is arranged in an upper handle region 72a of the hand-held power tool 26a. The upper handle region 72a is arranged, commencing at the contact unit 36a, after the processing tool 12a. In other words, the handle region 72a is arranged in the region of a cutting depth adjusting handle 74a.

It is possible to input at least one operating value by way of the input unit 20a. The input unit 20a comprises at least one input element 58a. The at least one input element 58a is formed by a touch button. Furthermore, the input unit 20a comprises at least one touch screen 22a. It is also feasible in this context that a person skilled in the art envisages other input elements that appear expedient, such as in particular push buttons, control dials and/or rocker switches. The input unit 20a is fixedly arranged on the hand-held power tool 26a. In other words, the input unit 20a is fixedly arranged on the hand-held power tool housing 32a. However, it is also feasible in this context that the input unit 20a is embodied separately from the hand-held power tool 26a. Moreover, it is feasible that the input unit 20a can be coupled in a detachable manner to the hand-held power tool 26a. It is likewise feasible that the input unit 20a is embodied as a mobile telephone. It is conceivable that the operating values can be transmitted in a wireless manner to the computer unit 16a.

The input unit 20a is provided for the purpose of transmitting at least one operating value to the detection unit 10a. For this purpose, the input unit 20a is connected in an electric manner to the computer unit 16a. It is possible by way of the input unit 20a to input a processing tool parameter, in particular a diameter of the processing tool 12a. Furthermore, it is possible by way of the input unit 20a to input a guide rail parameter. The guide rail parameter comprises a value regarding whether a guide rail is used during the processing procedure and/or regarding the thickness of the guide rail. Furthermore, it is possible by way of the input unit 20a to input a desired total cutting length. Furthermore, it is possible by way of the input unit 20a to input a command to reset the processing distance.

Furthermore, the detection unit 10a comprises a plunge depth sensor unit 18a that is provided for the purpose of acquiring a current plunge depth value of the processing tool 12a. In other words, the plunge depth sensor unit 18a is provided for the purpose of transmitting a current plunge depth angle 64a to the computer unit 16a. For this purpose, the plunge depth sensor unit 18a is connected in an electrical manner to the computer unit 16a.

For the purpose of performing a processing procedure, the hand-held tool reference point 60a is initially moved to a starting point on the workpiece 38. A diameter of the processing tool 12a is input at this point in time by way of the input unit 20a. Furthermore, the distance covered is reset by way of the input unit 20a. Furthermore, the desired cutting length is input by way of the input unit 20a. In addition, it is input by way of the input unit 20a whether a guide rail is used and where appropriate the thickness value of the guide rail is input.

It is possible in the computer unit 16a to calculate the position of the processing tool 12a, in particular a position of a rotational axis 62a of the processing tool 12a relative to the hand-held tool reference point 60a. Invariable parameters, such as in particular a distance between the plunge pivot axis 44a and the axis of rotation 62a and a distance from the plunge pivot axis 44a to the hand-held tool reference point 60a are stored in the computer unit 16a for the purpose of performing this calculation. It is possible by means of the computer unit 16a using the input diameter of the processing tool 12a, the current plunge depth angle 64a and the thickness value of the, when present, guide rail, to calculate the current cutting depth 50a. Furthermore, it is possible by means of the computer unit 16a to calculate the position of the cutting edge 48a relative to the hand-held tool reference point 60a. Consequently, it is also possible to calculate a current distance between the hand-held tool reference point 60a and the cutting edge 48a of the processing tool 12a in the computer unit 16a. It is feasible in this case that a second, rearward cutting edge 66a of the processing tool 12a can be calculated.

Using the position of the cutting edge 48a relative to the hand-held tool reference point 60a and the distance covered by the hand-held tool reference point 60a, it is possible by means of the computer unit 16a to calculate the processing distance of the processing tool 12a, in other words the actual cutting length in the workpiece 38a. Consequently, the computer unit 16a is provided for the purpose of detecting the processing distance in dependence upon the actual plunge depth value. In other words, the computer unit 16a is provided for the purpose of calculating the processing distance in dependence upon real time from the plunge depth value. The processing distance is calculated at continuous intervals of less than a second. The computer unit 16a is provided in addition for the purpose of calculating a remaining process distance. The detected processing distance is subtracted from the desired cutting length that has been input.

The hand-held power tool information device comprises an output unit 24a for the purpose of outputting the processing distance. The output unit 24a comprises at least one optical output means 68a. The optical output means 68a is formed by a liquid crystal display. The output unit 24a is fixedly arranged together with the input unit 20a on the power tool housing 32a. During the processing procedure, the hand-held power tool 26a moves in the processing direction 54a. The processing tool 12a is moved in a rotating manner through the workpiece 38a. The output unit 24a outputs at intervals a value for the remaining processing distance. Once the desired cutting length has been achieved, the processing tool 12a is guided out of the workpiece 38a by the user.

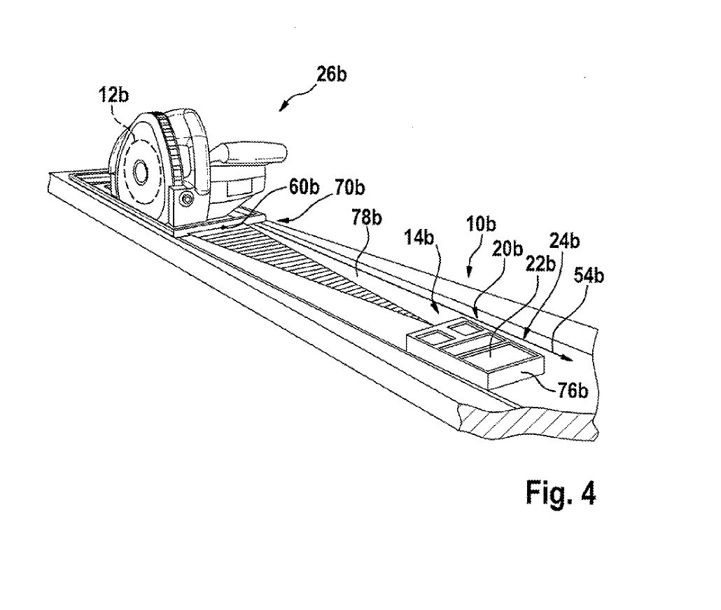

FIGS. 4 to 7 illustrate further exemplary embodiments of the disclosure. The descriptions hereinunder and the drawings are limited essentially to the differences between the exemplary embodiments, wherein with regard to like designated components, in particular with regard to components comprising like reference numerals, reference can also be made fundamentally to the drawings and/or to the description of other exemplary embodiments, in particular FIGS. 1 to 3. For the purpose of differentiating between the exemplary embodiments, the letter ‘a’ is placed after the reference numerals in the exemplary embodiment in FIGS. 1 to 3. The letter ‘a’ is replaced by the letters ‘b’ to ‘e’ in the exemplary embodiments in FIGS. 4 to 7.

FIG. 4 illustrates a system comprising a hand-held power tool 26b and a hand-held power tool information device. The hand-held power tool 26b is embodied as a plunge circular saw, as in the case of the first exemplary embodiment. The hand-held power tool information device comprises a detection unit 10b. The detection unit 10b comprises a distance sensor unit 14b. Moreover, the detection unit 10b comprises an input unit 20b. The input unit 20b comprises at least one touch screen 22b. Furthermore, the detection unit 10b comprises an output unit 24b. The detection unit 10b is embodied separately from the hand-held power tool 26b. The input unit 20b and the output unit 24b are arranged in an external housing 76b. A computer unit (not illustrated) as described in the first exemplary embodiment is likewise arranged in the housing 76b.

The hand-held power tool 26b lies on a guide rail 78b. The guide rail 78b does not comprise any magnetized regions. A hand-held tool reference point 60b is arranged on the hand-held power tool 26b in a front region 70b. The detection unit 10b is arranged after the hand-held power tool 26b when viewed in a processing direction 54b. In other words, the detection unit 10b lies on the guide rail 78b in a detachable manner. The distance sensor unit 14b detects a distance of the detection unit 10b to the hand-held tool reference point 60b. In other words, the distance sensor unit 14b detects an absolute distance to the hand-held tool reference point 60b. It is possible by way of example to perform a laser beam running time measurement. The hand-held power tool 26b is moved in the processing direction 54b during a processing procedure. The distance measured by the distance sensor unit 14b to the hand-held tool reference point 60b decreases.

It is possible by way of the input unit 20b to input a diameter of a processing tool 12b. Furthermore, it is possible by way of the input unit 20b to re-set a distance covered. Furthermore, it is possible by way of the input unit 20b to input a desired cutting length. In addition, it is possible by way of the input unit 20b to input whether a guide rail 78b is being used and where appropriate to input the thickness value of the guide rail 78b. Furthermore, it is possible to input a plunge depth. However, it is also feasible in this context that the plunge depth is transmitted in a wireless manner by a plunge depth sensor unit of the hand-held power tool 26b. Using the acquired distance value of the distance sensor unit 14b and the information input by way of the input unit 20b, the computer unit detects a remaining processing distance and outputs this value by way of the output unit 24b to a user.

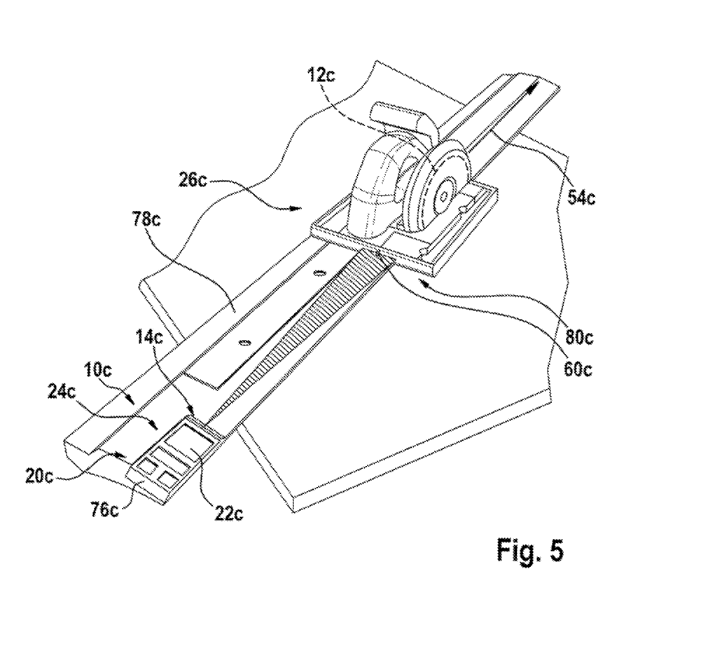

FIG. 5 illustrates a hand-held power tool 26c that corresponds to the hand-held power tool 26b of the second exemplary embodiment. The hand-held power tool information device is likewise almost identical to the second exemplary embodiment. In contrast to the second exemplary embodiment, a hand-held tool reference point 60c is arranged in a rear region 80c of the hand-held power tool 26c. The rear region 80c is arranged before a processing tool 12c when viewed in a processing direction 54c.

The hand-held power tool information device comprises a detection unit 10c. The detection unit 10c comprises a distance sensor unit 14c. Furthermore, the detection unit 10c comprises an input unit 20c. The input unit 20c comprises at least one touch screen 22c. Furthermore, the detection unit 10c comprises an output unit 24c. The detection unit 10c is embodied separately from the hand-held power tool 26c. The input unit 20c and the output unit 24c are arranged in an external housing 76c. A computer unit as described in the first exemplary embodiment is likewise arranged in the housing 76c (not illustrated).

The hand-held power tool 26c lies on a guide rail 78c. The guide rail 78c does not comprise any magnetized regions. The detection unit 10c is arranged before the hand-held power tool 26c when viewed in a processing direction 54c. In other words, the detection unit 10c lies in a detachable manner on the guide rail 78c. The distance sensor unit 14c detects a distance of the detection unit 10c to the hand-held tool reference point 60c. In other words, the distance sensor unit 14c detects an absolute distance to the hand-held tool reference point 60c. It is possible by way of example to perform a laser beam running time measurement. The hand-held power tool 26c is moved in the processing direction 54c during a processing procedure. The distance measured by the distance sensor unit 14c to the hand-held tool reference point 60c increases.

It is possible by way of the input unit 20c to input a diameter of a processing tool 12c. Furthermore, it is possible by way of the input unit 20c to reset a distance covered. Furthermore, it is possible by way of the input unit 20c to input a desired cutting length. Furthermore, it is possible by way of the input unit 20c to input whether a guide rail 78c is being used and where appropriate to input the thickness value of the guide rail 78c. Furthermore, it is possible to input a plunge depth. However, it is also feasible in this context that the plunge depth is transmitted in a wireless manner by a plunge depth sensor unit of the hand-held power tool 26c. Using the acquired distance value of the distance sensor unit 14c and the information input by way of the input unit 20c, the computer unit detects a remaining processing distance and outputs this value by way of the output unit 24c to a user.

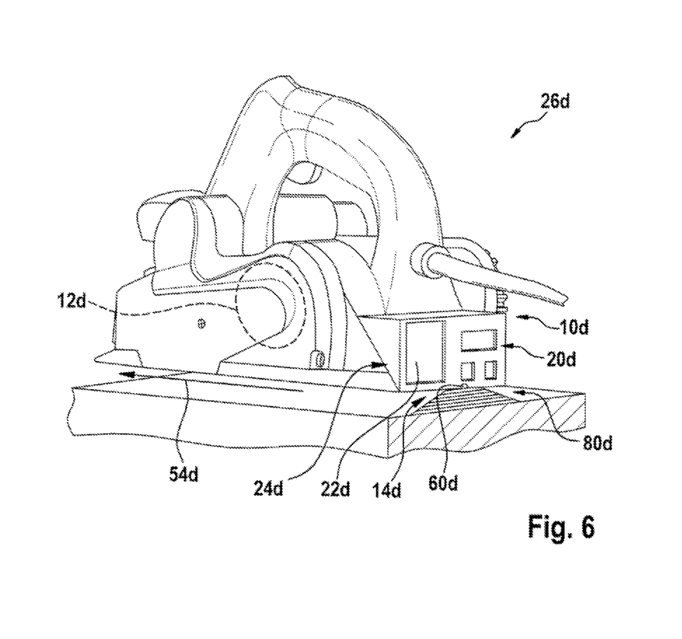

FIG. 6 illustrates a further hand-held power tool 26d and a hand-held power tool information device. The hand-held power tool 26d is embodied as a planing tool. The hand-held power tool information device comprises a detection unit 10d. The detection unit 10d comprises a distance sensor unit 14d. Furthermore, the detection unit 10d comprises an input unit 20d. The input unit 20d comprises at least one touch screen 22d. Furthermore, the detection unit 10d comprises an output unit 24d. The detection unit 10d is fixedly connected to the hand-held power tool 26d. The detection unit 10d is arranged in a rear region 80d of the hand-held power tool 26d. The detection unit 10d is consequently arranged before a processing tool 12d of the hand-held power tool 26d when viewed in the processing direction 54d.

A hand-held tool reference point 60d is arranged on the hand-held power tool 26d in the rear region 70d. The distance sensor unit 14d is provided for the purpose of acquiring a distance value in a manner that is independent of a guide rail. The distance value comprises a distance that is covered by the hand-held tool reference point 60d commencing from a starting point. The distance sensor unit 14d comprises a distance sensor element 56d. The distance sensor element 56d is formed by an incremental distance sensor.

It is possible by way of the input unit 20d to input a diameter of a processing tool 12d. Furthermore, it is possible by way of the input unit 20d to re-set a distance covered.

Furthermore, it is possible by way of the input unit 20d to input a desired cutting length. In addition, it is possible by way of the input unit 20b to input whether a guide rail 78d is being used and where appropriate to input the thickness value of the guide rail 78d. Furthermore, it is possible to input a plunge depth. However, it is also feasible in this context that the plunge depth is transmitted by a plunge depth sensor unit of the hand-held power tool 26d. Using the acquired distance value of the distance sensor unit 14d and the information input by way of the input unit 20d, the computer unit detects a remaining processing distance and outputs this value by way of the output unit 24d to a user.

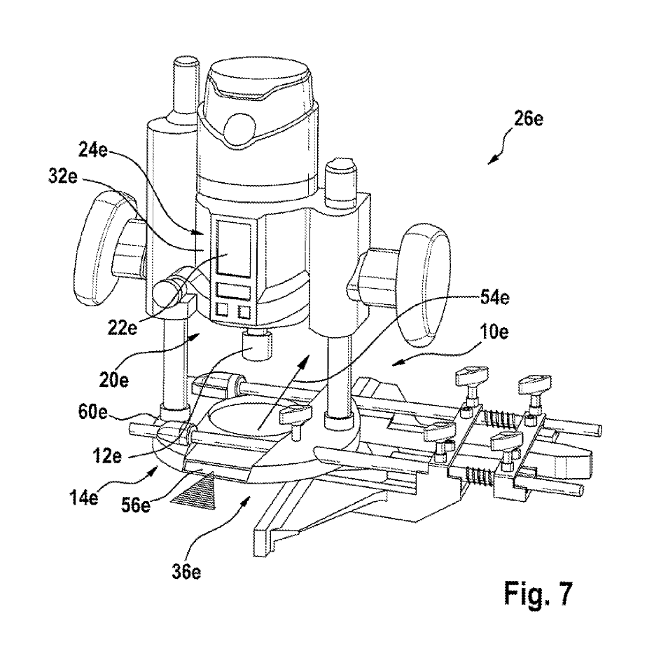

FIG. 7 illustrates a further hand-held power tool 26e and a hand-held power tool information device. The hand-held power tool 26e is embodied as a surface-milling tool. The hand-held power tool information device comprises a detection unit 10e. The detection unit 10e comprises a distance sensor unit 14e. Furthermore, the detection unit 10e comprises an input unit 20e. The input unit 20e comprises at least one touch screen 22e. Furthermore, the detection unit 10e comprises an output unit 24e. The detection unit 10e is fixedly connected to the hand-held power tool 26e. The detection unit 10e is arranged on a power tool housing 32e of the hand-held power tool 26e. The detection unit 10e is consequently arranged after a processing tool 12e when viewed commencing from a contact unit 36e. The processing tool 12e is formed by a milling tool.

A hand-held tool reference point 60e is arranged on the hand-held power tool 26e on the contact unit 36e. The distance sensor unit 14e is provided for the purpose of acquiring a distance value in a manner that is independent of a guide rail. The distance value comprises a distance that is covered by a hand-held tool reference point 60e commencing from a starting point. The distance sensor unit 14e comprises a distance sensor element 56e. The distance sensor element 56e is formed by an incremental distance sensor.

It is possible by way of the input unit 20e to input a diameter of a processing tool 12e. Furthermore, it is possible by way of the input unit 20e to re-set a distance covered. Furthermore, it is possible by way of the input unit 20e to input a desired processing length. In addition, it is possible by way of the input unit 20e to input whether a guide rail is being used and where appropriate to input the thickness value of the guide rail. Using the acquired distance value of the distance sensor unit 14e and the information input by way of the input unit 20e, the computer unit detects a remaining processing distance and outputs this value by way of the output unit 24e to a user.

What is claimed is:

1. A hand-held power tool information device comprising:
at least one detection unit configured to detect at least one processing distance covered by a cutting edge of a processing tool on a workpiece independently of a guide rail.

2. The hand-held power tool information device of claim 1, wherein the at least one detection unit comprises a distance sensor unit configured to detect at least one distance value.

3. The hand-held power tool information device of claim 2, wherein the at least one detection unit further comprises a computer unit configured to calculate the at least one processing distance based on at least one processing tool parameter and the at least one distance value.

4. The hand-held power tool information device of claim 1, wherein the at least one detection unit comprises at least one plunge depth sensor unit configured to identify a current plunge depth value of the at least one processing tool.

5. The hand-held power tool information device of claim 4, wherein the computer unit is configured to calculate the at least one processing distance based on the current plunge depth value.

6. The hand-held power tool information device of claim 1, further comprising an input unit configured to receive an input corresponding to at least one operating value.

7. The hand-held power tool information device of claim 6, wherein the input unit comprises at least one touch screen.

8. The hand-held power tool information device of claim 2, wherein the distance sensor unit further comprises at least one distance sensor element configured to identify the at least one distance value.

9. The hand-held power tool information device of claim 3, wherein the computer unit is configured to at least one of store and calculate a distance from a hand-held tool reference point to the cutting edge of the processing tool.

10. The hand-held power tool information device of claim 1, further comprising an output unit configured to generate an output corresponding to the at least one processing distance.

11. A system comprising:
a hand-held power tool having a cutting edge; and
a hand-held power tool information device, including:
at least one detection unit configured to detect at least one processing distance covered by the cutting edge independently of a guide rail.

12. The system of claim 11, wherein the handheld power tool is a hand-held circular saw.

13. The hand-held power tool information device of claim 8, wherein in the at least one distance sensor element optically identifies the at least one distance value.
